(19) United States
(12) Patent Application Publication
(10) Pub. No.: US 2026/0234043 A1
(43) Pub. Date: Aug. 13, 2026

(54) DIALYSIS WATER PURIFICATION

(71) Applicant: Mozarc Medical US LLC, Minneapolis, MN (US)

(72) Inventors: Evan J. Myers, Blaine, MN (US); Sukalyan Dutta, Mounds View, MN (US)

(21) Appl. No.: 19/533,794

(22) Filed: Feb. 9, 2026

Related U.S. Application Data
(60) Provisional application No. 63/756,930, filed on Feb. 11, 2025.

(51) Int. Cl. C02F 9/00; C02F 1/00; C02F 1/32; C02F 1/44; C02F 1/469; C02F 1/68

(52) U.S. Cl. CPC C02F 9/00; C02F 1/001; C02F 1/32; C02F 1/441; C02F 1/4695; C02F 1/68; C02F 2201/004; C02F 2201/005; C02F 2201/4611; C02F 2201/46145; C02F 2209/40

(57) ABSTRACT

In some examples, a system includes a reverse osmosis unit and an electrodeionization unit. The reverse osmosis unit may include a reverse osmosis inlet configured to be coupled to a water source, and a reverse osmosis permeate outlet configured to discharge a reverse osmosis purified stream. The electrodeionization unit may include an electrodeionization inlet fluidically coupled to and downstream of the reverse osmosis permeate outlet and configured to receive the reverse osmosis purified stream, and an electrodeionization concentrate outlet configured to discharge an electrodeionization concentrate stream. The electrodeionization concentrate outlet may be fluidically coupled to the reverse osmosis inlet and configured to recycle at least a portion of the electrodeionization concentrate stream to the reverse osmosis inlet.

### CROSS-REFERENCE TO RELATED APPLICATIONS

This application claims the benefit of U.S. Provisional Patent Application Serial No. 63/756,930, filed February 11, 2025, which is incorporated by reference herein in its entirety.

### TECHNICAL FIELD

The present disclosure generally relates to dialysis, for example, systems and techniques for purifying water for dialysis.

### BACKGROUND

Dialysis fluid may be prepared at a point of use, for example, by adding one or more components to a carrier, for example, water or an aqueous fluid. For example, the dialysis fluid may be used for peritoneal dialysis or hemodialysis.

### SUMMARY

In general, the present disclosure describes systems and techniques for dialysis, for example, systems and techniques for purifying water for dialysis. One type of dialysis for the treatment of kidney failure is peritoneal dialysis (PD), during which a patient’s abdomen (the peritoneum) filters blood while the blood remains inside the body. Peritoneal dialysis therapy uses a dialysis fluid including water and at least one dialysis agent (e.g., an electrolyte or dextrose) that is introduced into the peritoneal cavity of the patient, and cleans the blood of waste products. Another type of dialysis is hemodialysis, during which blood is removed from the body, filtered in a dialyzer (e.g., by exchanging waste to a dialysate across a membrane), and returned to the body.

A significant amount of water may be used in dialysis. For example, fluids for dialysis may be prepared by adding one or more components to water in a preparator system. The preparator system may store purified water in a water-for-injection (WFI) tank. For example, reverse osmosis and/or electrodeionization may be used to purify water from a feed water source to prepare WFI that is sent to the WFI tank. Such purification may result in a loss of significant amount of water in waste streams.

Systems and techniques according to the present disclosure may be used to purify water for dialysis, for example, to prepare water-for-injection (WFI). For example, at least one aqueous stream may be recycled from a reverse osmosis process or an electrodeionization process to reduce loss of water associated with purification processes.

In some examples, an example system includes a reverse osmosis unit and an electrodeionization unit. The reverse osmosis unit may include a reverse osmosis inlet configured to be coupled to a water source, and a reverse osmosis permeate outlet configured to discharge a reverse osmosis purified stream. The electrodeionization unit may include an electrodeionization inlet fluidically coupled to and downstream of the reverse osmosis permeate outlet and configured to receive the reverse osmosis purified stream, and an electrodeionization concentrate outlet configured to discharge an electrodeionization concentrate stream. The electrodeionization concentrate outlet may be fluidically coupled to the reverse osmosis inlet and configured to recycle at least a portion of the electrodeionization concentrate stream to the reverse osmosis inlet.

In some examples, an example technique includes feeding water from a water source to a reverse osmosis unit. The technique may further include feeding a reverse osmosis purified stream from the reverse osmosis unit to an electrodeionization unit. The technique may further include recycling at least a portion of an electrodeionization concentrate stream discharged by the electrodeionization unit to the reverse osmosis unit.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a conceptual block diagram illustrating an example system configured to purify water for dialysis and including a reverse osmosis unit and an electrodeionization unit.

FIG. 1B is a conceptual block diagram illustrating an example pre-filtration assembly configured to pre-filter water for purification by the system of FIG. 1A.

FIG. 2 is a block diagram illustrating an example configuration of a computing device.

FIG. 3 is a flow diagram illustrating an example technique for purifying water for dialysis.

FIG. 4A is a chart illustrating response surface effect plots for reverse osmosis recycle rate and electrodeionization recycle rate relative to a mean of permeate conductivity.

FIG. 4B is a chart illustrating a response surface interaction plot for reverse osmosis recycle rate and electrodeionization recycle rate relative to a mean of permeate conductivity.

### DETAILED DESCRIPTION

The present disclosure generally relates to systems for dialysis, for example, systems and techniques for purifying water for dialysis.

Dialysis treatments (e.g., peritoneal dialysis or hemodialysis) use a relatively large amount of fluid. Dialysis fluid may include one or more dialysis agents dissolved in water. Depending on the type of dialysis, the dialysis fluid may be circulated within a peritoneal cavity of a patient (peritoneal dialysis) or may receive impurities and contaminants from blood across a membrane (hemodialysis). Dialysis fluid may be prepared at a point of use in a dialysis system (e.g., in a preparator) by combining one or more dialysis agents dissolved with water. Dialysis systems may be configured to purify water from a water source so that purified water is used in the preparator for preparing dialysis fluid.

A water purification system for dialysis may include a reverse osmosis unit and an electrodeionization unit, each of which generate respective waste streams including impurities or contaminants removed from source water. For example, the reverse osmosis unit may treat water from a water source by passing the water through a membrane, generating a reverse osmosis permeate stream (that passes the membrane) having a relatively high purity and a reverse osmosis concentrate stream (residual stream that does not pass the membrane) that includes impurities or contaminants removed from the water. The electrodeionization unit may further refine or polish the reverse osmosis permeate stream generated by the reverse osmosis unit by an electrically-driven deionization process to remove one or more target ions that may remain in the reverse osmosis permeate stream. The electrodeionization unit may generate an electrodeionization purified stream having an even greater purity than the reverse osmosis permeate stream, and an electrodeionization concentrate stream having a lower purity than the electrodeionization purified stream. The electrodeionization purified stream can be sent as water-for-injection (WFI) to a preparator, or to a WFI tank that is coupled to or part of the preparator.

Water purification systems may discard the reverse osmosis concentrate stream and the electrodeionization concentrate stream to a drain. However, in the course of purification, a relatively large proportion of water may be discarded in the reverse osmosis concentrate stream and the electrodeionization concentrate stream. For example, 20% of reverse osmosis recovery and 50-75% electrodeionization recovery is typical (10-15% overall water recovery or 85-90% water loss).

Example systems and techniques according to the present disclosure may recycle at least a portion of an electrodeionization concentrate stream. In some examples, at least a portion of a reverse osmosis concentrate stream may also be recycled. In some examples, an example system includes a reverse osmosis unit and an electrodeionization unit. The reverse osmosis unit may include a reverse osmosis inlet configured to be coupled to a water source, and a reverse osmosis permeate outlet configured to discharge a reverse osmosis purified stream. The electrodeionization unit may include an electrodeionization inlet fluidically coupled to and downstream of the permeate outlet and configured to receive the reverse osmosis purified stream, and an electrodeionization concentrate outlet configured to discharge an electrodeionization concentrate stream. The electrodeionization concentrate outlet may be fluidically coupled to the reverse osmosis inlet and configured to recycle at least a portion of the electrodeionization concentrate stream to the reverse osmosis inlet. In some examples, the reverse osmosis unit is configured to generate a reverse osmosis concentrate stream, and at least a portion of the reverse osmosis concentrate stream may also be recycled to the reverse osmosis inlet. While the electrodeionization concentrate stream is relatively less pure than an electrodeionization purified stream, the electrodeionization concentrate stream may yet be relatively purer than the source water (e.g., being purer than tap water). Thus, the electrodeionization concentrate stream may be recycled without substantially increasing (and indeed, even decreasing) an overall proportion of contaminants or impurities introduced in the reverse osmosis inlet. Such recycling of the electrodeionization concentrate stream to the reverse osmosis inlet (and optionally, recycling of the reverse osmosis concentrate stream) may increase an overall yield of water purification (the proportion of purified water generated per unit volume or unit mass of source water), compared to systems and techniques in which the electrodeionization concentrate stream is not recycled.

Increasing the overall yield of water purification may reduce overall water. In particular, the water that is recycled (as part of the electrodeionization concentrate stream and/or the reverse osmosis concentrate stream) can substitute some of the source water fed to the reverse osmosis inlet, and reduce flow rate of source water into the overall system while maintaining substantially a same output of purified water generated by the system. As an example, a system that does not recycle an electrodeionization concentrate stream or a reverse osmosis concentrate stream may operate with a source water (e.g., tap water) flow rate of 1.0 L/min and produce 300 mL/min of purified water. In contrast, a system that recycles the electrodeionization concentrate stream at an electrodeionization recycle rate of 100 mL/min and the reverse osmosis concentrate stream at a reverse osmosis recycle rate of 300 mL/min (a total recycle rate of 400 mL/min) may allow a relatively lower source water flow rate of 0.6 L/min, while still producing 300 mL/min of purified water (WFI). In such an example, the water purification yield is increased from a value of 30% to a value of 50%.

Water purification systems may include a pre-filtration assembly configured to pre-filter water prior to reverse osmosis and electrodeionization processing. For example, the pre-filtration assembly may be configured to remove or inactivate sediment, ions, odorants, microorganisms, organics, perfluoro-compounds, disinfection byproducts, or colorants by using one or more of a sediment filter, a resin filter, an ultraviolet unit, or an activated carbon filter. The components of the pre-filtration assembly may need relatively greater maintenance or replacement if a relatively higher flow rate of source water is pre-filtered for a predetermined output flow rate of purified water. By reducing the flow rate of source water required to generate the predetermined output flow rate of purified water, systems and techniques according to the present disclosure may thus extend the service life and reduce down-time of the pre-filtration assembly (or components thereof). Thus, the effective lifecycle of components used in pre-filtration may be increased, relative to systems and techniques in which one or both of the electrodeionization concentrate stream and/or the reverse osmosis concentrate stream are not recycled.

Moreover, recycling at least portions of the electrodeionization concentrate stream and/or the reverse osmosis concentrate stream reduces the overall drainage of water (discarded water), compared to systems in which one or both of the electrodeionization concentrate stream and/or the reverse osmosis concentrate stream are not recycled. Thus, an end user of the water purification system (for example, a dialysis patient or a clinic) may benefit from lower drainage flow rates, and a reduction in overall complexity or drainage capacity of plumbing or drainage systems. Additionally, the source water flow rate and reverse osmosis feed flow rate can be controlled independently by appropriately modifying flow rates of recycle streams. For example, the flow rates of various streams can be maintained at predetermined rates to reduce or prevent fouling or damage.

To facilitate recycling while having acceptable throughput of water, in some examples, systems and techniques according to the present disclosure may use flow or pressure direction, modification, or control elements, for example, one or more manifolds, proportional valves, flow restrictors, pressure regulators, or check valves. For example, flow in an electrodeionization concentrate drain line and/or a reverse osmosis concentrate drain line may be restricted by a flow restrictor (e.g., a proportional valve). A pressure regulator may be positioned between a water source and a reverse osmosis inlet to regulate pressure of fluid ultimately fed to the reverse osmosis inlet (e.g., pressure at a reverse osmosis pump). Check valves may be positioned along an electrodeionization concentrate recycle line and/or a reverse osmosis concentrate recycle line to prevent back flows and protect equipment from impurities and contaminants in the electrodeionization concentrate stream and/or the reverse osmosis concentrate stream.

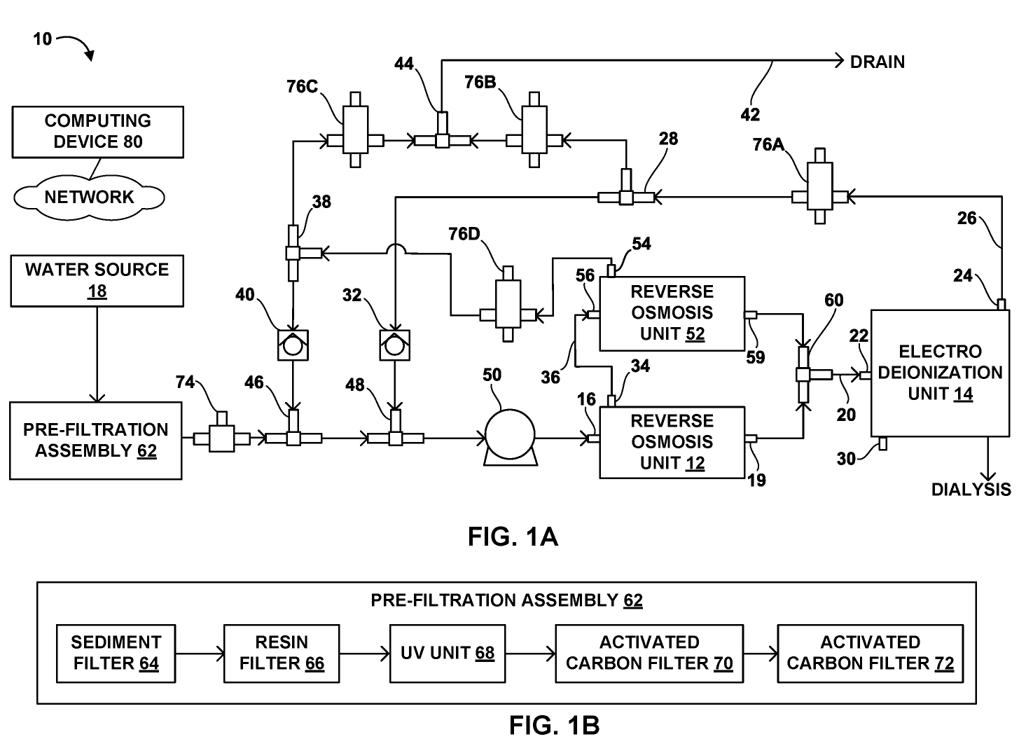

FIG. 1A is a conceptual block diagram illustrating an example system 10 configured to purify water for dialysis and including a reverse osmosis unit 12 and an electrodeionization unit 14. Reverse osmosis unit 12 may include one or more semipermeable membranes. Reverse osmosis unit 12 may include a reverse osmosis inlet 16 configured to be coupled to a water source 18, and a reverse osmosis permeate outlet 19 configured to discharge a reverse osmosis purified stream. Reverse osmosis unit 12 may be configured to drive water from reverse osmosis inlet 16 through the one or more semipermeable membranes. For example, a reverse osmosis pump may apply pressure to reverse osmosis unit 12 (for example, sufficient to overcome osmotic pressure) to cause water from water source 18 (e.g., including a relatively small concentration impurities or contaminants) to flow from a feed side of the semipermeable membrane with a higher concentration of one or more solutes (for example, impurities or contaminants) to a permeate side of the semipermeable membrane with a lower concentration of the one or more solutes. The water in the permeate side with reduced impurities or contaminants is discharged via reverse osmosis permeate outlet 19 as the reverse osmosis purified stream. The reverse osmosis purified stream may be transported in a reverse osmosis purified line 20. The water remaining on the feed side with impurities or contaminants is discharged as a reverse osmosis concentrate stream.

Electrodeionization unit 14 may include an electrodeionization inlet 22 fluidically coupled to and downstream of reverse osmosis permeate outlet 19 and configured to receive the reverse osmosis purified stream via reverse osmosis purified line 20. For example, electrodeionization inlet 22 may be fluidically coupled to reverse osmosis purified line 20 to transport the reverse osmosis purified stream to electrodeionization inlet 22. Electrodeionization unit 14 may include resins (e.g., anionic and cationic exchange resins) bounded by membranes (e.g., anionic and cationic membranes). Water flows through the resins from electrodeionization inlet 22 toward an outlet. Electrodeionization unit 14 may be configured to apply an electric field to water received through electrodeionization inlet 22 (for example, in a direction perpendicular to a flow direction). The electric field is configured to selective drive anions and cations from water flowing along the resins across cationic exchange membranes and anionic exchange membranes to a waste stream (referred to as an electrodeionization concentrate stream), leaving purified (deionized) water to flow toward an electrodeionization product outlet (referred to as an electrodeionization purified stream).

Electrodeionization unit 14 further includes an electrodeionization concentrate outlet 24 configured to discharge the electrodeionization concentrate stream. For example, the electrodeionization concentrate stream may be transported in electrodeionization concentrate line 26. While the electrodeionization concentrate stream is relatively less pure than the electrodeionization purified stream, the electrodeionization concentrate stream may yet be comparably pure or even purer than water from water source 18. Thus, at least a portion of water fed to reverse osmosis inlet 16 may be substituted by at least a portion of the electrodeionization concentrate stream. For example, electrodeionization concentrate outlet 24 may be fluidically coupled to reverse osmosis inlet 16 and configured to recycle at least a portion of the electrodeionization concentrate stream to reverse osmosis inlet 16. In some examples, electrodeionization concentrate line 26 is fluidically coupled to reverse osmosis inlet 16 to transport at least a portion of the electrodeionization concentrate stream to reverse osmosis inlet 16. Recycling at least a portion of the electrodeionization concentrate stream to reverse osmosis inlet 16 may reduce the flow rate required for water from water source 18. For example, a reduced flow rate of water from water source 18 may be used in combination with the recycled portion of the electrodeionization concentrate stream, in comparison to flow rate of water in a scheme in which the electrodeionization stream is not recycled.

System 10 may further include an electrodeionization concentrate manifold 28 fluidically coupled between electrodeionization concentrate outlet 24 and reverse osmosis inlet 16 and configured to recycle at least a portion of electrodeionization concentrate stream (e.g., from electrodeionization concentrate line 26) to reverse osmosis inlet 16. Electrodeionization concentrate manifold 28 may be positioned at any suitable position along electrodeionization concentrate line 26, or may otherwise be fluidically coupled to electrodeionization concentrate line 26. Electrodeionization concentrate manifold 28 may be configured to recycle any suitable proportion of the electrodeionization concentrate stream to reverse osmosis inlet 16 (e.g., by flow regulation and/or pressure regulation via one or more pressure regulators or valves fluidically coupled to an inlet or an outlet of electrodeionization concentrate manifold 28). For example, electrodeionization concentrate manifold 28 may be configured to recycle at least 5%, at least 10%, at least 20%, at least 25%, at least 30%, at least 40%, at least 50%, at least 60%, at least 75%, or at least 90%, or 100% of the electrodeionization concentrate stream to reverse osmosis inlet 16. In some examples, electrodeionization concentrate manifold 28 is configured to recycle 100% or less, 90% or less, 75% or less, 60% or less, 50% or less, 40% or less, 30% or less, 25% or less, 20% or less, or 10% or less, of the electrodeionization concentrate stream to reverse osmosis inlet 16. In some examples, electrodeionization concentrate manifold 28 is configured to recycle a constant proportion of the electrodeionization concentrate stream to reverse osmosis inlet 16. In other examples, electrodeionization concentrate manifold 28 is configured to recycle a varying proportion of the electrodeionization concentrate stream to reverse osmosis inlet 16 (e.g., varying with time, or in response to flow conditions or other parameters, or in response to changes in flow rate of water from water source 18). In some examples, electrodeionization concentrate manifold 28 is electronically controlled (e.g., by a computing device as described elsewhere in the present disclosure).

Electrodeionization unit 14 further includes an electrodeionization product outlet 30 configured to discharge an electrodeionization purified stream. For example, electrodeionization unit 14 may be configured to treat the reverse osmosis purified stream transported via reverse osmosis purified line 20 to electrodeionization unit 14, and generate the electrodeionization purified stream having a greater purity (a lower concentration of one or more impurities or contaminants) than the reverse osmosis purified stream. Typically, electrodeionization unit 14 removes impurities or contaminants from the reverse osmosis purified stream into the electrodeionization concentrate stream discharged from electrodeionization concentrate outlet 24, and the remaining portion having a reduced concentration of one or more impurities or contaminants forms the electrodeionization purified stream discharged via electrodeionization product outlet 30. Thus, electrodeionization unit 14 generates the electrodeionization concentrate stream (discharged from electrodeionization concentrate outlet 24) and the electrodeionization purified stream (discharged from electrodeionization product outlet 30) from the reverse osmosis purified stream (received at electrodeionization inlet 22). In some examples, electrodeionization unit 14 is the sole electrodeionization unit in system 10. In other examples, system 10 may include additional electrodeionization units (e.g., two or more electrodeionization units).

The electrodeionization purified stream can be used for dialysis or other applications where a relatively high purity of water is beneficial. In some examples, system 10 further includes a water-for-injection (WFI) container (not shown in the figures) fluidically coupled to product outlet 30 of the electrodeionization unit. The WFI container may be fluidically coupled to or be a part of a dialysis system, for example, a preparator (not shown in the figures). For example, the dialysis system may be configured to add one or more dialysis agents to the purified water generated by electrodeionization unit 14 (discharged from electrodeionization product outlet 30) to generate a dialysis fluid.

System 10 may further include at least one valve configured to prevent inadvertent backflow along one or more lines. For example, system 10 may further include an electrodeionization check valve 32 between electrodeionization concentrate outlet 24 and reverse osmosis inlet 16 and configured to prevent backflow from reverse osmosis inlet 16 to electrodeionization concentrate outlet 24. In some examples in which system 10 includes electrodeionization concentrate manifold 28 and electrodeionization check valve 32, electrodeionization check valve 32 may be between electrodeionization concentrate manifold 28 and reverse osmosis inlet 16. Thus, electrodeionization check valve 32 may prevent backflow in a direction from reverse osmosis inlet 16 toward electrodeionization concentrate manifold 28.

Like electrodeionization unit 14, reverse osmosis unit 12 may also be configured to generate two streams from its input. For example, reverse osmosis unit 12 may be configured to treat water received at reverse osmosis inlet 16, and generate the reverse osmosis purified stream having a greater purity (a lower concentration of one or more impurities or contaminants) than water received at reverse osmosis inlet 16. Typically, reverse osmosis unit 12 removes impurities or contaminants from the water received at reverse osmosis inlet 16 by passing the water across a reverse osmosis membrane, and the permeate transported across the reverse osmosis membrane forms the reverse osmosis purified stream discharged via reverse osmosis permeate outlet 19. The remaining portion of the water (including residual impurities or contaminants that are not transported across the reverse osmosis membrane) forms a reverse osmosis concentrate stream. Thus, reverse osmosis unit 12 may further include a reverse osmosis concentrate outlet 34 configured to discharge the reverse osmosis concentrate stream. Thus, reverse osmosis unit 12 generates the reverse osmosis concentrate stream (discharged from reverse osmosis concentrate outlet 34) and the reverse osmosis purified stream (discharged from reverse osmosis permeate outlet 19) from the reverse osmosis inlet stream (received at electrodeionization inlet 22).

Reverse osmosis concentrate outlet 34 may be fluidically coupled to reverse osmosis inlet 16 and configured to recycle at least a portion of the reverse osmosis concentrate stream to reverse osmosis inlet 16. For example, system 10 may include a reverse osmosis recycle line 36 fluidically coupled to reverse osmosis concentrate outlet 34 and configured to recycle at least a portion of the reverse osmosis concentrate stream to reverse osmosis inlet 16.

System 10 may further include a reverse osmosis concentrate manifold 38 fluidically coupled between reverse osmosis concentrate outlet 34 and reverse osmosis inlet 16 and configured to recycle at least a portion of the reverse osmosis concentrate stream (e.g., from reverse osmosis recycle line 36) to reverse osmosis inlet 16. For example, reverse osmosis concentrate manifold 38 may be configured to recycle a predetermined portion of a stream by flow regulation and/or pressure regulation via one or more pressure regulators or valves fluidically coupled to an inlet or an outlet of reverse osmosis concentrate manifold 38. Reverse osmosis concentrate manifold 38 may be positioned at any suitable position along reverse osmosis recycle line 36, or may otherwise be fluidically coupled to reverse osmosis recycle line 36. For example, reverse osmosis concentrate manifold 38 may be configured to recycle at least 5%, at least 10%, at least 20%, at least 25%, at least 30%, at least 40%, at least 50%, at least 60%, at least 75%, at least 90%, or 100%, of the reverse osmosis concentrate stream to reverse osmosis inlet 16. In some examples, reverse osmosis concentrate manifold 38 is configured to recycle 100% or less, 90% or less, 75% or less, 60% or less, 50% or less, 40% or less, 30% or less, 25% or less, 20% or less, or 10% or less, of the reverse osmosis concentrate stream to reverse osmosis inlet 16. In some examples, reverse osmosis concentrate manifold 38 is configured to recycle a constant proportion of the reverse osmosis concentrate stream to reverse osmosis inlet 16. In other examples, reverse osmosis concentrate manifold 38 is configured to recycle a varying proportion of the electrodeionization concentrate stream to reverse osmosis inlet 16 (e.g., varying with time, or in response to flow conditions or other parameters). In some examples, reverse osmosis concentrate manifold 38 is electronically controlled (e.g., by a computing device as described elsewhere in the present disclosure).

Similar to electrodeionization check valve 32, system 10 may further include a reverse osmosis check valve 40 between reverse osmosis concentrate outlet 34 and reverse osmosis inlet 16 and configured to prevent backflow from reverse osmosis inlet 16 to reverse osmosis concentrate outlet 34. In some examples in which system 10 includes reverse osmosis concentrate manifold 38 and reverse osmosis check valve 40, reverse osmosis check valve 40 may be between reverse osmosis concentrate manifold 38 and reverse osmosis inlet 16. Thus, reverse osmosis check valve 40 may prevent backflow in a direction from reverse osmosis inlet 16 toward reverse osmosis concentrate manifold 38.

System 10 may further include a drain line 42 fluidically coupled to one or both of electrodeionization concentrate outlet 24 or reverse osmosis concentrate outlet 34. Drain line 42 is configured to drain one or more streams to a drain. For example, system 10 may be configured to drain at least a portion of one or both of the reverse osmosis concentrate stream or the electrodeionization concentrate stream via drain line 42. Thus, one or both of electrodeionization concentrate outlet 24 or reverse osmosis concentrate outlet 34 may be fluidically coupled to drain line 42. In some examples, one or both of electrodeionization concentrate outlet 24 or reverse osmosis concentrate outlet 34 are directly fluidically coupled to drain line 42. In other examples, one or both of electrodeionization concentrate outlet 24 or reverse osmosis concentrate outlet 34 are fluidically coupled to drain line 42 via a manifold, a valve, or another fluid transport element.

In some examples, system 10 further includes a drain manifold 44 fluidically coupled between drain line 42 and one or both of electrodeionization concentrate outlet 24 or reverse osmosis concentrate outlet 34. Drain manifold 44 is configured to divert at least a portion of one or both of the electrodeionization concentrate stream or the reverse osmosis concentrate stream to drain line 42. For example, drain manifold 44 may be coupled to electrodeionization concentrate outlet 24 via electrodeionization concentrate line 26, or to reverse osmosis concentrate outlet 34 via reverse osmosis recycle line 36. In some examples, drain manifold 44 is between reverse osmosis concentrate manifold 38 and drain line 42. In some examples, drain manifold 44 is between electrodeionization concentrate manifold 28 and drain line 42. In some examples, drain manifold 44 is between electrodeionization concentrate manifold 28 and reverse osmosis concentrate manifold 38. Thus, system 10 may be configured to discharge any suitable proportion of the electrodeionization concentrate stream or the reverse osmosis concentrate stream to drain line 42 via drain manifold 44. For example, a remaining portion of the electrodeionization concentrate stream or of the reverse osmosis concentrate stream that is not recycled within system 10 (e.g., to reverse osmosis inlet 16) may be discharged to drain line 42 via drain manifold 44.

System 10 may include additional manifolds or valves configured to combine or separate streams in any suitable relative proportion. For example, system 10 may further include one or both of a first manifold 46 between reverse osmosis check valve 40 and reverse osmosis inlet 16, or a second manifold 48 between electrodeionization check valve 32 and reverse osmosis inlet 16. In examples in which system 10 includes both first manifold 46 and second manifold 48, second manifold 48 may be positioned between first manifold 46 and reverse osmosis inlet 16. In some examples, first manifold 46 is positioned between second manifold 48 and reverse osmosis inlet 16. First manifold 46 or second manifold 48 may be respectively configured to combine any suitable proportion of a first inlet stream and a second inlet stream to form a combined stream. For example, first manifold 46 may combine any suitable proportion of (i) the reverse osmosis concentrate stream ultimately received from reverse osmosis concentrate outlet 34 (e.g., via reverse osmosis concentrate manifold 38 or through reverse osmosis check valve 40) and (ii) water from water source 18 to generate a first combined stream sent to second manifold 48. Thus, first manifold 46 may be configured to generate a first combined stream including a predetermined proportion of the reverse osmosis concentrate stream and water (e.g., from water source 18). Further, second manifold 48 may combine any suitable proportion of (i) the electrodeionization concentrate stream ultimately received from electrodeionization concentrate outlet 24 (e.g., via electrodeionization concentrate manifold 28 or through electrodeionization check valve 32) and (ii) the first combined stream from first manifold 46 to generate a second combined stream sent to reverse osmosis inlet 16. Thus, second manifold 48 may be configured to generate the second combined stream including a predetermined proportion of the first blend and the electrodeionization concentrate stream. In this way, any suitable proportion of one or more of water from water source 18, a recycled portion of the reverse osmosis concentrate stream, or a recycled portion of the electrodeionization concentrate stream may be fed to reverse osmosis inlet 16.

System 10 may include one or more pumps to facilitate transport of one or more streams at predetermined flow rates. For example, system 10 may include a pump 50 between water source 18 and reverse osmosis inlet 16, configured to pump water in a direction from water source 18 toward reverse osmosis unit 12. In some examples, pump 50 provides sufficient motive force to cause the water from water source 18 to be circulated or transported through one or more of reverse osmosis unit 12 (e.g., with appropriate pressure), electrodeionization unit 14, discharged through reverse osmosis product outlet 19, discharged through drain line 42, or recycled in one or more streams as described herein.

In some examples, reverse osmosis unit 12 is the sole reverse osmosis unit in system 10. In other examples, system 10 may include additional reverse osmosis units (e.g., two or more reverse osmosis units). For example, reverse osmosis unit 12 may be a first reverse osmosis unit, and system 10 may further include a second reverse osmosis unit 52 fluidically coupled to first reverse osmosis unit 12 and electrodeionization unit 14. Second reverse osmosis unit 52 may be identical to first reverse osmosis unit 12, or differ from first reverse osmosis unit 12 in one or more operational or geometric characteristics. In some examples, reverse osmosis concentrate outlet 34 is a first reverse osmosis concentrate outlet, reverse osmosis inlet 16 is a first reverse osmosis inlet, reverse osmosis permeate outlet 19 is a first reverse osmosis permeate outlet, the reverse osmosis purified stream discharged from first reverse osmosis permeate outlet 19 is a first reverse osmosis purified stream, and the reverse osmosis concentrate stream discharged from first reverse osmosis concentrate outlet 34 is a first reverse osmosis concentrate stream. In some such examples, second reverse osmosis unit 52 includes a second reverse osmosis concentrate outlet 54, a second reverse osmosis inlet 56, and a second reverse osmosis permeate outlet 59.

Second reverse osmosis unit 52 may be configured to treat the first reverse osmosis concentrate stream received from the first reverse osmosis concentrate outlet 34 of first reverse osmosis unit 12, and generate a second reverse osmosis purified stream discharged from second permeate outlet 59, and a second reverse osmosis concentrate stream discharged from second reverse osmosis concentrate outlet 54. Thus, at least a portion of the first reverse osmosis concentrate stream generated by first reverse osmosis unit 12 may be further purified by second reverse osmosis unit 52. In some such examples, system 10 may further include a reverse osmosis manifold 60 fluidically coupled to the first reverse osmosis outlet 19 and the second reverse osmosis outlet 59, and configured to combine the first reverse osmosis purified stream discharged from first reverse osmosis outlet 19 and the second reverse osmosis purified stream discharged from second reverse osmosis outlet 59 in any suitable proportion as a combined reverse osmosis stream fed to electrodeionization inlet 22. For example, the reverse osmosis manifold 60 may be coupled to electrodeionization inlet 22 via reverse osmosis purified line 20.

In examples in which system 10 includes both first reverse osmosis unit 12 and second reverse osmosis unit 52, the second reverse osmosis concentrate stream from second reverse osmosis concentrate outlet 54 of second reverse osmosis unit 52 may be recirculated to first reverse osmosis inlet 16 of first reverse osmosis unit 12. In some such examples, second reverse osmosis concentrate outlet 54 may be fluidically coupled to reverse osmosis concentrate manifold 38, which in turn may discharge a predetermined proportion (some, more than a majority, less than all, or all) of the second reverse osmosis concentrate stream toward reverse osmosis inlet 16.

Water from water source 18 may be directly fed to reverse osmosis inlet 16, or may be pre-treated or pre-filtered prior to a reverse osmosis process. For example, system 10 may further include a pre-filtration assembly 62 upstream of reverse osmosis inlet 16 and configured to pre-filter water from water source 18.

FIG. 1B is a conceptual block diagram illustrating example pre-filtration assembly 62 configured to pre-filter water for purification by system 10 of FIG. 1A. Pre-filtration assembly 62 may include one or more of a sediment filter 64, a resin filter 66, an ultra-violet (UV) unit 68, or an activated carbon filter 70. In some examples, activated carbon filter 70 is a first activated carbon filter, and pre-filtration assembly 62 may include a second activated carbon filter 72. Sediment filter 64 may be configured to remove sediment, debris, or particulates above a predetermined sediment threshold. Resin filter 66 may be configured to remove ions such as calcium and magnesium that may otherwise form deposits on a reverse osmosis membrane of reverse osmosis unit 12. UV unit 68 may be configured to sterilize the water by eliminating UV susceptible microorganisms, which in turn may reduce biofouling of the reverse osmosis membrane of reverse osmosis unit 12. Activated carbon filter 70 (and additionally, activated carbon filter 72) may be configured to remove odorants, colorants, or other molecular species (e.g., residual chlorine or organic compounds) that may not be removed by other components of the pre-filtration assembly. Thus, pre-filtration assembly 62 may include one or more components that help extend the life of the system by removing sediment, debris, or other particles and/or components (e.g., chlorine from tap water) that may be harmful to reverse osmosis unit 12 (or any other reverse osmosis unit such as reverse osmosis unit 52), or to electrodeionization unit 14.

System 10 may further include at least one pressure regulator 74. In some examples, pressure regulator 74 is downstream of pre-filtration assembly 62 and upstream of reverse osmosis inlet 16. In examples in which system 10 includes first manifold 46, pressure regulator 74 may be positioned between pre-filtration assembly 62 and first manifold 46. Pressure regulator 74 may ensure that a pressure of water fed to pump 50 for feeding to reverse osmosis inlet 16 is relatively constant within a predetermined pressure range adequate for the reverse osmosis process performed by reverse osmosis unit 12, and to generally circulate water in a sufficient and relatively constant flow rate through system 10. In some examples, pressure regulator 74 is a first pressure regulator downstream of pre-filtration assembly 62, and system 10 further includes a second pressure regulator upstream of pre-filtration assembly 62.

System 10 may further include one or more flow restrictors to control a flow rate and/or pressure drop along one or more lines or streams. For example, system 10 may include a flow restrictor 76A downstream of electrodeionization concentrate outlet 24. In some examples, system 10 may include additional flow restrictors, for example, flow restrictor 76B between electrodeionization concentrate manifold 28 and drain manifold 44, flow restrictor 76C between reverse osmosis concentrate manifold 38 and drain manifold 44, and 76D between reverse osmosis unit 12 (or reverse osmosis unit 52) (or reverse osmosis concentrate outlet 34 and/or reverse osmosis concentrate outlet 54) and reverse osmosis concentrate manifold 38. One or more flow restrictors may include a proportional valve. For example, each of flow restrictors 76A, 76B, 76C, and 76D may include a respective proportional valve.

By recycling at least a portion of the electrodeionization concentrate stream and/or the reverse osmosis concentrate stream to reverse osmosis inlet 16, system 10 may be configured to exhibit a relatively higher water purification yield compared to a system in which one or both of the electrodeionization concentrate stream or the reverse osmosis concentrate stream are not recycled. Further, flow rates and/or pressure drops may be regulated using one or more components of system 10 (e.g., valves, manifolds, pumps, or flow restrictors). For example, system 10 may be configured to purify water with a water purification yield of at least 30%, at least 35%, at least 40%, at least 45%, at least 50%, at least 55%, at least 60%, at least 65%, at least 70%, at least 75%, at least 80%, at least 85%, at least 90%, or at least 95%.

In some examples, a dialysis system (e.g., a peritoneal dialysis system or a hemodialysis system) may include one or more components described with reference to system 10, or may include system 10, and be configured to prepare a dialysis fluid by combining water purified by system 10 with at least one dialysis agent. In some such examples, the dialysis system may further include a water-for-injection (WFI) container fluidically coupled to electrodeionization unit 14 (e.g., to electrodeionization product outlet 30). In some examples, the dialysis system may further include at least one dialysis agent container fluidically coupled to the WFI container. For example, the at least one dialysis agent container may be configured to introduce or mix at least one dialysis agent with water from the WFI container. In some examples, the WFI container and/or the at least one dialysis agent may be part of or be fluidically coupled to a preparator.

In some examples, system 10 further includes a computing device 80, configured to control one or more components of system 10, or an operation of system 10 as a whole. For example, computing device 80 may be configured to one or more of receive a signal from, send a signal to, control an operation of, or direct a flow of fluid to, from, or between, one or more components of system 10 (e.g., one or more of reverse osmosis unit 12; electrodeionization unit 14; water source 18; RO unit 52; pre-filtration assembly 62; and one or more valves, pumps, or flow restrictors).

Computing device 80 may be configured to adjust or control parameters or operation of system 10 (e.g., in response to a user input, a control signal, or some flow parameter or concentration of a species in a stream in system 10 sensed by a sensor or a component). For example, computing device 80 may be configured to control flow rates, recycle rates, recycle proportions, and/or pressures along one or more lines, or between or through one or more components of system 10. In some examples, computing device 80 is configured to operate system 10 to achieve at least a predetermined water purification yield.

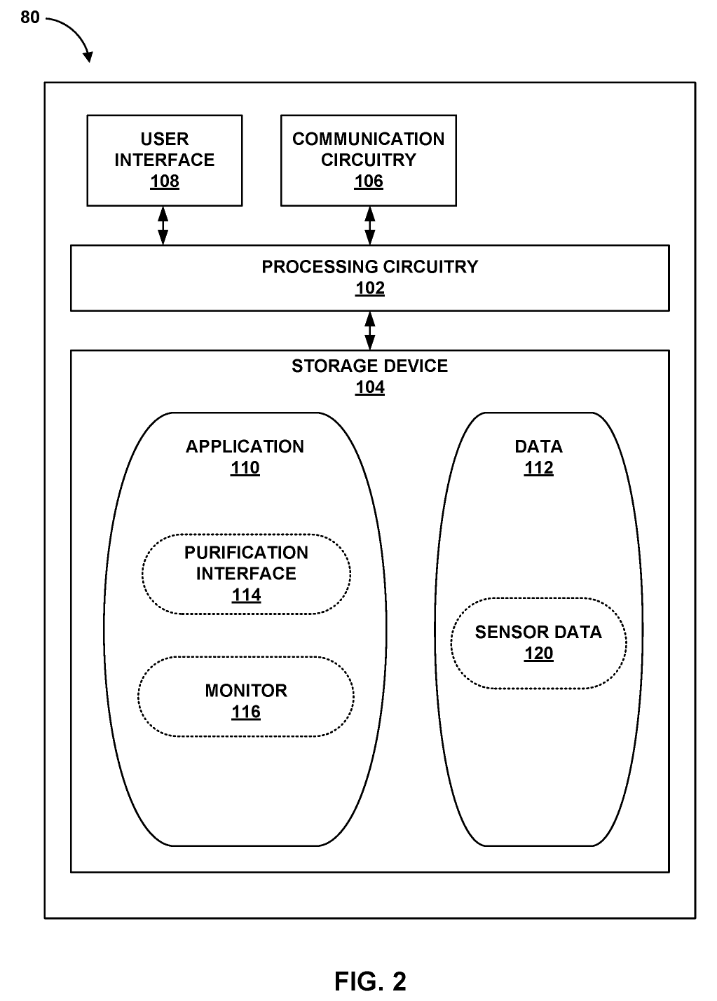

FIG. 2 is a block diagram illustrating an example configuration of computing device 80 of FIG. 1A. Computing device 80 may include a workstation, a tablet computer, a laptop computer, or a desktop computer. As shown in the example of FIG. 2, computing device 80 includes processing circuitry 102, storage device 104, communication circuitry 106, and a user interface 108. While computing device 80 may be a stand-alone device as shown in FIG. 2, in other examples, computing device 80 may be any component or system that includes processing circuitry or other suitable computing environment for executing software instructions and, for example, need not necessarily include one or more elements shown in FIG. 2 (e.g., in some examples components such as storage device 104 may not be co-located or in the same housing or structure as other components).

Processing circuitry 102, in some examples, is configured to implement functionality and/or process instructions for execution within at least one computing device 80. For example, processing circuitry 102 may be capable of processing instructions, including at least one application 110, stored in storage device 104. Examples of processing circuitry 102, as well as other processors, processing circuitry, controllers, control circuitry, and the like, described herein, may include any combination of integrated circuitry, discrete logic circuitry, analog circuitry, such as one or more microprocessors, digital signal processors (DSPs), application specific integrated circuits (ASICs), or field-programmable gate arrays (FPGAs). In some examples, processing circuitry 102 includes multiple components, such as any combination of one or more microprocessors, one or more DSPs, one or more ASICs, or one or more FPGAs, as well as other discrete or integrated logic circuitry, and/or analog circuitry.

Storage device 104 (which can also be referred to as a memory) may be configured to store information within computing device 80, including at least one application 110 and data 112. Data 112 may include sensor data 120 received from one or more sensors (e.g., pressure, flow rate, or concentration of one or more species). Storage device 104, in some examples, is a computer-readable storage medium. In some examples, storage device 104 includes a temporary memory or a volatile memory. Storage device 104, in one example, is used by at least one application 110 running on computing device 80 to temporarily store information during program execution. Storage device 104, in some examples, also includes one or more memories configured for long-term storage of information, e.g., including non-volatile storage elements. Examples of such non-volatile storage elements include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Computing device 80 utilizes communication circuitry 106 to communicate with other devices, such as other computing devices, and system 10 of FIG. 1A. Communication circuitry 106 may include a network interface card, such as an Ethernet card, an optical transceiver, a radio frequency transceiver, or any other type of device that can send and receive information. Other examples of such network interfaces may include 3G, 4G, 5G, and WiFi radios.

User interface 108 may be configured to provide output to a user using tactile, audio, or video stimuli and receive input from a user through tactile, audio, or video feedback. User interface 108 may include, as examples, a presence-sensitive display, a mouse, a keyboard, a voice responsive system, video camera, microphone, or any other type of device for detecting a command from a user, a sound card, a video graphics adapter card, or any other type of device for converting a signal into an appropriate form understandable to humans or machines, a speaker, a display device, such as, but not limited to, cathode ray tube (CRT) monitor, a liquid crystal display (LCD), or any other type of device that can generate intelligible output to a user. In some examples, a presence-sensitive display includes a touch-sensitive screen.

At least one application 110 executable by processing circuitry 102 of computing device 80 may include a purification interface application 114 and a monitor application 116 that may utilize sensor data 120 or other data (e.g., flow rate data, valve position data, pressure data, concentration data, or any other data associated with any component of system 10) obtained during operation of system 10 to monitor purification of water by system 10. Purification interface application 114 may control one or more of preparation, flow, or delivery of purified water toward a water-for-injection container or toward a dialysis system or a preparator.

Execution of purification interface application 114 and monitor application 116 by processing circuitry 102 configures computing device 80 to interface with system 10. For example, monitor application 116 configures computing device 80 to communicate with one or more components of system 10 via communication circuitry 106. Processing circuitry 102 may receive a signal from one or more components indicative of a status or parameter associated with that component, and store state data 120 in storage device 104. Purification interface application 114 also configures user interface 108 for a user to interact with system 10. One or more of purification interface application 114, monitor application 116, or any other suitable application or interface of computing device 80 may cause processing circuity 102 and computing device 34 to perform any of the techniques described herein related to water purification by system 10.

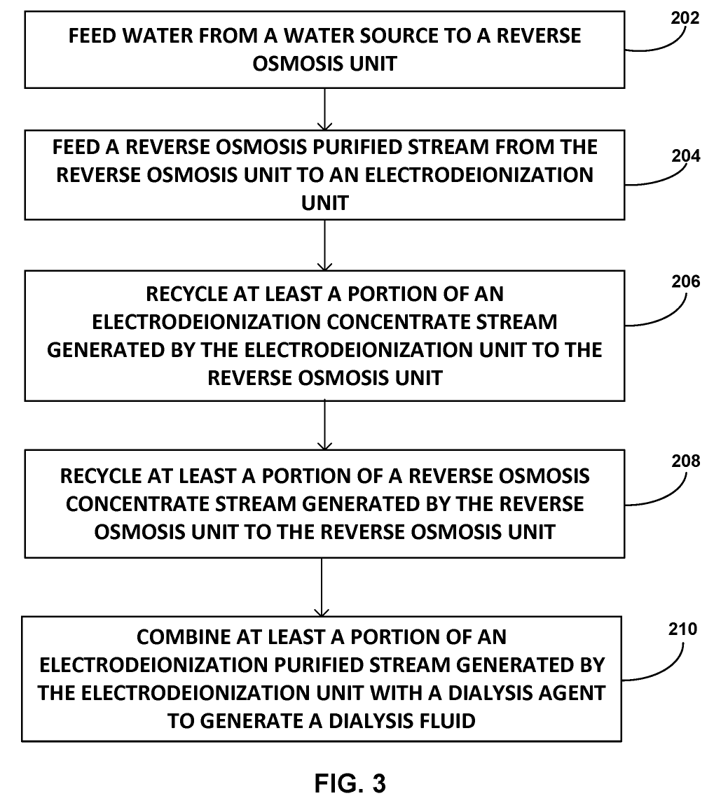

FIG. 3 is a flow diagram illustrating an example technique for purifying water for dialysis. The technique of FIG. 3 is described with reference to system 10 of FIG. 1A as an example. However, the technique of FIG. 3 may be performed using any suitable system, and system 10 of FIG. 1A may be used to perform any suitable technique.

In some examples, the example technique includes feeding water from water source 18 to reverse osmosis unit 12 (202). For example, computing device 80 may control one or more of water source 18, pre-filtration assembly 62, pressure regulator 74, first manifold 46, second manifold 48, or pump 50 to deliver a predetermined flow rate of water at reverse osmosis inlet 16.

The technique may further include feeding a reverse osmosis purified stream from reverse osmosis unit 12 (e.g., from reverse osmosis outlet 19) to electrodeionization unit 14 (204). For example, computing device 80 may control one or more of reverse osmosis unit 12, reverse osmosis permeate outlet 19, reverse osmosis concentrate outlet 34, reverse osmosis pump 50, reverse osmosis permeate outlet 59, reverse osmosis manifold 60, reverse osmosis unit 52, reverse osmosis concentrate outlet 54, or flow restrictors 76A, 76B, 76C, or 76D, to deliver a predetermined flow rate of water from reverse osmosis unit 12 (and/or reverse osmosis unit 52) to electrodeionization inlet 22.

The technique may further include recycling at least a portion of an electrodeionization concentrate stream discharged by electrodeionization unit 14 to reverse osmosis unit 12 (206). For example, computing device 80 may control one or more of electrodeionization unit 14, electrodeionization concentrate outlet 24, flow restrictor 76A, electrodeionization concentrate manifold 28, electrodeionization check valve 32, or second manifold 48, to deliver a predetermined flow rate of the electrodeionization concentrate stream from electrodeionization unit 14 to reverse osmosis inlet 16. In some examples, the technique further includes draining at least a portion of the electrodeionization concentrate stream (e.g., via drain line 42). For example, computing device 80 may control one or more of electrodeionization unit 14, electrodeionization concentrate outlet 24, flow restrictor 76A, electrodeionization concentrate manifold 28, flow restrictor 76B, or drain manifold 44 to deliver a predetermined flow rate of the electrodeionization concentrate stream from electrodeionization unit 14 to drain line 42.

In some examples, the technique may further include recycling one or both of (i) at least a portion of an electrodeionization purified stream discharged by electrodeionization unit 14 or (ii) at least a portion of the reverse osmosis purified stream from reverse osmosis unit 12 (e.g., from reverse osmosis outlet 19) to reverse osmosis unit 12. For example, the electrodeionization product outlet 30 may be fluidically coupled to reverse osmosis inlet 16 (e.g., by a line optionally including a valve) and a predetermined proportion of the electrodeionization purified stream from electrodeionization product outlet 30 may be recycled to reverse osmosis inlet 16. Such recycling may facilitate maintaining predetermined flow rates within system 10 in cases where there is a temporary reduction or failure in water from water source 18.

In some examples, the technique further includes recycling at least a portion of a reverse osmosis concentrate stream discharged by reverse osmosis unit 12 to reverse osmosis unit 12 (e.g., from reverse osmosis concentrate outlet 34 to reverse osmosis inlet 12) (208). For example, computing device 80 may control one or more of reverse osmosis unit 12, reverse osmosis unit 52, reverse osmosis concentrate outlet 34, reverse osmosis concentrate outlet 54, flow restrictor 76D, reverse osmosis concentrate manifold 38, reverse osmosis check valve 40, first manifold 46, second manifold 48, or pump 50 to deliver a predetermined flow rate of the reverse osmosis concentrate stream from reverse osmosis unit 12 to reverse osmosis inlet 16. In some examples, the technique further includes draining at least a portion of the reverse osmosis concentrate stream (e.g., via drain line 42). For example, computing device 80 may control one or more of reverse osmosis unit 12, reverse osmosis unit 52, reverse osmosis concentrate outlet 34, reverse osmosis concentrate outlet 54, flow restrictor 76D, reverse osmosis concentrate manifold 38, flow restrictor 76C, or drain manifold 44 to deliver a predetermined flow rate of the reverse osmosis concentrate stream from reverse osmosis unit 12 to drain line 42.

Computing device 80 may control flow restrictors 76A, 76B, 76C, and 76D to cause predetermined portions of streams to flow through respective manifolds, valves, or other flow elements coupled to flow restrictors 76A, 76B, 76C, and 76D, and ultimately, to one or more components of system 10. For example, computing device 80 may be configured to control flow restrictor 76A to control a yield of electrodeionization unit 14, flow restrictor 76B to control a proportion of the electrodeionization concentrate stream that is recycled and/or drained, flow restrictor 76C to control a proportion of the reverse osmosis concentrate stream that is recycled and/or drained, and flow restriction 76D to control a yield of reverse units 12 and/or 52.

The technique may further include pre-filtering water from water source 18 to generate a pre-filtered water stream (e.g., by pre-filtration assembly 62) and feeding the pre-filtered water stream to reverse osmosis unit 12. For example, computing device 80 may control water source 18, pre-filtration assembly 62 (or one or more components of pre-filtration assembly 62), pressure regulator 74, first manifold 46, second manifold 48, or pump 50 to deliver a predetermined flow rate of water to reverse osmosis inlet 16.

The technique may further include combining at least a portion of the electrodeionization purified stream with at least one dialysis agent to generate a dialysis fluid (210). For example, the electrodeionization purified stream from electrodeionization product outlet 30 may be sent to a WFI container and/or a preparator, and the purified water from the electrodeionization purified stream may be combined with at least one dialysis agent to generate the dialysis fluid in the preparator or another component of a dialysis system.

While systems and techniques according to the present disclosure may be used for purifying water for dialysis, they may also be used for other applications in which water is purified by reverse osmosis and/or electrodeionization.

### Examples

### Example 1

A computational simulation was performed to compare water purification yield in a first water purification system without a reverse osmosis concentrate recycle or an electrodeionization concentrate recycle stream and a second water purification system with an electrodeionization concentrate recycle stream and a reverse osmosis recycle stream. Both systems included two reverse osmosis units and an electrodeionization unit. In the first system, the feed inlet flow rate from the water source was 1.0 L/min to the reverse osmosis inlet. Both reverse osmosis units had a reverse osmosis permeate flow rate of 0.2 L/min, for a total combined reverse osmosis permeate flow rate of 0.4 L/min, which was fed to the electrodeionization unit. The electrodeionization unit generated an electrodeionization product with an electrodeionization product flow rate of 0.3 L/min. The first reverse osmosis unit had a first reverse osmosis concentrate flow rate of 0.8 L/min which was fed to the second reverse osmosis unit, which had a second reverse osmosis concentrate flow rate of 0.6 L/min. The second reverse osmosis concentrate was discarded to the drain line. An electrodeionization concentrate stream having a flow rate of 0.1 L/min was discarded to the drain. Thus, the overall waste was 0.7 L/min (reverse osmosis + electrodeionization waste), and overall yield was 30% (0.3 L/min product flow from feed rate of 1.0 L/min). The daily water consumption was 100.0 L.

In the second system, the feed inlet flow rate from the water source was 0.4 L/min to the reverse osmosis inlet. Both reverse osmosis units had a reverse osmosis permeate flow rate of 0.2 L/min, for a total combined reverse osmosis permeate flow rate of 0.4 L/min, which was fed to the electrodeionization unit. The electrodeionization unit generated an electrodeionization product with an electrodeionization product flow rate of 0.3 L/min. The first reverse osmosis unit had a first reverse osmosis concentrate flow rate of 0.8 L/min which was fed to the second reverse osmosis unit, which had a second reverse osmosis concentrate flow rate of 0.6 L/min. 0.1 L/min of the second reverse osmosis concentrate was discarded to the drain line, and the remaining 0.5 L/min of the second reverse osmosis concentrate was recycled to the reverse osmosis inlet. An electrodeionization concentrate stream having a flow rate of 0.1 L/min was completely recycled to the reverse osmosis inlet. The overall recycle was 0.6 L/min (0.5 L/min from reverse osmosis, 0.1 L/min from electrodeionization). Thus, the overall waste was 0.1 L/min (portion of reverse osmosis), and overall yield was 75% (0.3 L/min product flow from feed rate of 0.4 L/min). The daily water consumption was 40.4 L. Thus, daily water consumption was significantly lower and the overall yield was significantly higher in the second system compared to the first system.

### Example 2

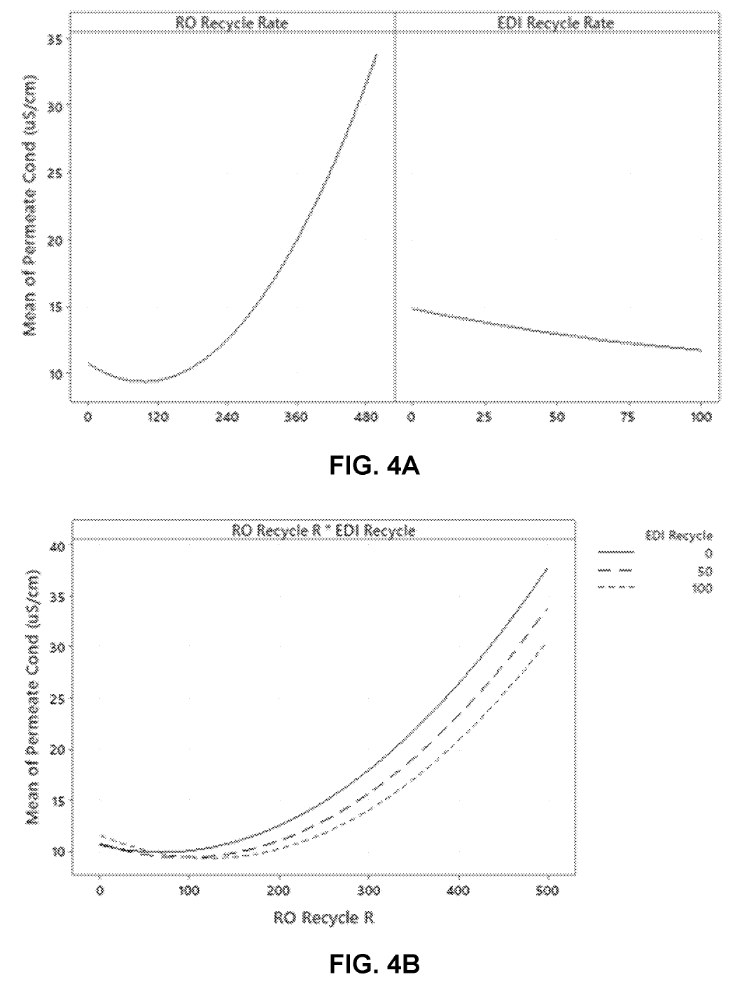

A Response Surface analysis was performed for a two-factor design in which reverse osmosis recycle rates and electrodeionization recycle rates were the two factors. Two replicates were performed per run, and 3 center point runs were performed. Soft water was considered. The nominal reverse osmosis permeate flow rate was 400 mL/min, and the nominal electrodeionization product flow rate was 300 mL/min. The reverse osmosis inlet flow rate was 1.0 L/min. The maximum electrodeionization recycle rate was 100 mL/min, and the maximum reverse osmosis recycle rate was 500 mL/min. The reverse osmosis permeate had a conductivity of 30µS/cm. The overall yield was 75% and consumption was 40 L/min. The effect plot and interaction plots for the reverse osmosis recycle rate and electrodeionization recycle rate relative to the mean of permeate conductivity is shown in FIGS. 4A and 4B.

The following enumerated clauses describe examples according to the present disclosure:

Clause 1: A system including: a reverse osmosis unit including: a reverse osmosis inlet configured to be coupled to a water source, and a reverse osmosis permeate outlet configured to discharge a reverse osmosis purified stream; and an electrodeionization unit including: an electrodeionization inlet fluidically coupled to and downstream of the reverse osmosis permeate outlet and configured to receive the reverse osmosis purified stream, and an electrodeionization concentrate outlet configured to discharge an electrodeionization concentrate stream, where the electrodeionization concentrate outlet is fluidically coupled to the reverse osmosis inlet and configured to recycle at least a portion of the electrodeionization concentrate stream to the reverse osmosis inlet.

Clause 2: The system of clause 1, further including an electrodeionization concentrate manifold fluidically coupled between the electrodeionization concentrate outlet and the reverse osmosis inlet and configured to recycle at least the portion of the electrodeionization concentrate stream to the reverse osmosis inlet.

Clause 3: The system of clause 2, further including an electrodeionization check valve between the electrodeionization concentrate outlet and the reverse osmosis inlet and configured to prevent backflow from the reverse osmosis inlet to the electrodeionization concentrate outlet.

Clause 4: The system of clause 3, where the electrodeionization check valve is between the electrodeionization concentrate manifold and the reverse osmosis inlet.

Clause 5: The system of any of clauses 1 to 4, where the reverse osmosis unit further includes a reverse osmosis concentrate outlet configured to discharge a reverse osmosis concentrate stream, and where the reverse osmosis concentrate outlet is fluidically coupled to the reverse osmosis inlet and configured to recycle at least a portion of the reverse osmosis concentrate stream to the reverse osmosis inlet.

Clause 6: The system of clause 5, further including a reverse osmosis concentrate manifold fluidically coupled between the reverse osmosis concentrate outlet and the reverse osmosis inlet and configured to recycle at least the portion of the reverse osmosis concentrate stream to the reverse osmosis inlet.

Clause 7: The system of clause 6, further including a reverse osmosis check valve between the reverse osmosis concentrate outlet and the reverse osmosis inlet and configured to prevent backflow from the reverse osmosis inlet to the reverse osmosis concentrate outlet.

Clause 8: The system of clause 7, where the reverse osmosis check valve is between the reverse osmosis concentrate manifold and the reverse osmosis inlet.

Clause 9: The system of any of clauses 5 to 8, where a drain line is fluidically coupled to one or both of the electrodeionization concentrate outlet or the reverse osmosis concentrate outlet.

Clause 10: The system of clause 9, further including a drain manifold fluidically coupled between the drain line and one or both of the electrodeionization concentrate outlet or the reverse osmosis concentrate outlet, the drain manifold being configured to divert at least a portion of one or both of the electrodeionization concentrate stream or the reverse osmosis concentrate stream to the drain line.

Clause 11: The system of clause 10, where the drain manifold is between the reverse osmosis concentrate manifold and the drain line.

Clause 12: The system of clauses 9 or 10, where the drain manifold is between the electrodeionization concentrate manifold and the drain line.

Clause 13: The system of clause 12, where the drain manifold is between the electrodeionization concentrate manifold and the reverse osmosis concentrate manifold.

Clause 14: The system of any of clauses 1 to 13, where the reverse osmosis unit is a first reverse osmosis unit, and where the system further includes a second reverse osmosis unit fluidically coupled to the first reverse osmosis unit and the electrodeionization unit.

Clause 15: The system of any of clauses 1 to 14, further including a pre-filtration assembly upstream of the reverse osmosis inlet and configured to pre-filter water from the water source.

Clause 16: The system of clause 15, where the pre-filtration assembly includes one or more of a sediment filter, a resin filter, an ultra-violet unit, or an activated carbon filter.

Clause 17: The system of clause 15 or 16, further including a pressure regulator downstream of the pre-filtration assembly and upstream of the reverse osmosis inlet.

Clause 18: The system of any of clauses 1 to 17, further including a flow restrictor downstream of the electrodeionization concentrate outlet.

Clause 19: The system of clause 18, where the flow restrictor includes a proportional valve.

Clause 20: The system of any of clauses 1 to 19, where the electrodeionization unit further includes an electrodeionization product outlet configured to discharge an electrodeionization purified stream, and where the system further includes a water-for-injection container fluidically coupled to the product outlet of the electrodeionization unit.

Clause 21: The system of any of clauses 1 to 20, where the system is configured to purify water with a water purification yield of at least 50%.

Clause 22: The system of clause 21, where the water purification yield is at least 75%.

Clause 23: A dialysis system including the system of any of clauses 1 to 22 and configured to prepare a dialysis fluid by combining water purified by the system with at least one dialysis agent.

Clause 24: The dialysis system of clause 23, further including a water-for-injection container fluidically coupled to the electrodeionization unit.

Clause 25: The dialysis system of clause 24, further including at least one dialysis agent container fluidically coupled to the water-for-injection container.

Clause 26: A method including: feeding water from a water source to a reverse osmosis unit; feeding a reverse osmosis purified stream from the reverse osmosis unit to an electrodeionization unit; and recycling at least a portion of an electrodeionization concentrate stream discharged by the electrodeionization unit to the reverse osmosis unit.

Clause 27: The method of clause 26, further including recycling one or both of (i) at least a portion of an electrodeionization purified stream discharged by the electrodeionization unit to the reverse osmosis unit or (ii) at least a portion of the reverse osmosis purified stream from the reverse osmosis unit to the reverse osmosis unit.

Clause 28: The method of clauses 26 or 27, further including draining at least a portion of the electrodeionization concentrate stream.

Clause 29: The method of any of clauses 26 to 28, further including recycling at least a portion of a reverse osmosis concentrate stream discharged by the reverse osmosis unit to the reverse osmosis unit.

Clause 30: The method of clause 29, further including draining at least a portion of the reverse osmosis concentrate stream.

Clause 31: The method of any of clauses 26 to 30, further including pre-filtering water from the water source to generate a pre-filtered water stream and feeding the pre-filtered water stream to the reverse osmosis unit.

Clause 32: The method of any of clauses 26 to 31, further including combining at least a portion of the electrodeionization purified stream with at least one dialysis agent to generate a dialysis fluid.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module, unit, or circuit for purposes of clarity, it should be understood that the techniques of this disclosure may be performed by a combination of units, modules, or circuitry associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors that include processing circuitry, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “processing circuitry” as used herein may refer to any of the foregoing structure or any other physical structure suitable for implementation of the described techniques. Also, the techniques could be fully implemented in one or more circuits or logic elements.

The above detailed descriptions of examples of the technology are not intended to be exhaustive or to limit the technology to the precise form disclosed above. Although specific examples of the technology are described above for illustrative purposes, various equivalent modifications are possible within the scope of the technology, as those skilled in the relevant art will recognize. For example, while steps are presented in a given order, alternative examples may perform steps in a different order. The various examples described herein may also be combined to provide further examples. All references cited herein are incorporated by reference as if fully set forth herein.

Various examples have been described. These and other examples are within the scope of the following claims.

What is claimed is:

1. A system comprising:
a reverse osmosis unit comprising:
a reverse osmosis inlet configured to be coupled to a water source, and
a reverse osmosis permeate outlet configured to discharge a reverse osmosis purified stream; and
an electrodeionization unit comprising:
an electrodeionization inlet fluidically coupled to and downstream of the reverse osmosis permeate outlet and configured to receive the reverse osmosis purified stream, and
an electrodeionization concentrate outlet configured to discharge an electrodeionization concentrate stream,
wherein the electrodeionization concentrate outlet is fluidically coupled to the reverse osmosis inlet and configured to recycle at least a portion of the electrodeionization concentrate stream to the reverse osmosis inlet.

2. The system of claim 1, further comprising an electrodeionization concentrate manifold fluidically coupled between the electrodeionization concentrate outlet and the reverse osmosis inlet and configured to recycle at least the portion of the electrodeionization concentrate stream to the reverse osmosis inlet.

3. The system of claim 2, further comprising an electrodeionization check valve between the electrodeionization concentrate outlet and the reverse osmosis inlet and configured to prevent backflow from the reverse osmosis inlet to the electrodeionization concentrate outlet.

4. The system of claim 3, wherein the electrodeionization check valve is between the electrodeionization concentrate manifold and the reverse osmosis inlet.

5. The system of claim 4, wherein the reverse osmosis unit further comprises a reverse osmosis concentrate outlet configured to discharge a reverse osmosis concentrate stream, and wherein the reverse osmosis concentrate outlet is fluidically coupled to the reverse osmosis inlet and configured to recycle at least a portion of the reverse osmosis concentrate stream to the reverse osmosis inlet.

6. The system of claim 5, further comprising a reverse osmosis concentrate manifold fluidically coupled between the reverse osmosis concentrate outlet and the reverse osmosis inlet and configured to recycle at least the portion of the reverse osmosis concentrate stream to the reverse osmosis inlet.

7. The system of claim 6, further comprising a reverse osmosis check valve between the reverse osmosis concentrate outlet and the reverse osmosis inlet and configured to prevent backflow from the reverse osmosis inlet to the reverse osmosis concentrate outlet.

8. The system of claim 5, wherein a drain line is fluidically coupled to one or both of the electrodeionization concentrate outlet or the reverse osmosis concentrate outlet.

9. The system of claim 1, wherein the reverse osmosis unit is a first reverse osmosis unit, and wherein the system further comprises a second reverse osmosis unit fluidically coupled to the first reverse osmosis unit and the electrodeionization unit.

10. The system of claim 1, further comprising a pre-filtration assembly upstream of the reverse osmosis inlet and configured to pre-filter water from the water source.

11. The system of claim 1, further comprising a flow restrictor downstream of the electrodeionization concentrate outlet.

12. The system of claim 1, wherein the electrodeionization unit further comprises an electrodeionization product outlet configured to discharge an electrodeionization purified stream, and
wherein the system further comprises a water-for-injection container fluidically coupled to the product outlet of the electrodeionization unit.

13. The system of claim 1, wherein the system is configured to purify water with a water purification yield of at least 50%.

14. A method comprising:
feeding water from a water source to a reverse osmosis unit;
feeding a reverse osmosis purified stream from the reverse osmosis unit to an electrodeionization unit; and
recycling at least a portion of an electrodeionization concentrate stream discharged by the electrodeionization unit to the reverse osmosis unit.

15. The method of claim 14, further comprising recycling one or both of (i) at least a portion of an electrodeionization purified stream discharged by the electrodeionization unit to the reverse osmosis unit or (ii) at least a portion of the reverse osmosis purified stream from the reverse osmosis unit to the reverse osmosis unit.

16. The method of claim 14, further comprising draining at least a portion of the electrodeionization concentrate stream.

17. The method of claim 14, further comprising recycling at least a portion of a reverse osmosis concentrate stream discharged by the reverse osmosis unit to the reverse osmosis unit.

18. The method of claim 17, further comprising draining at least a portion of the reverse osmosis concentrate stream.

19. The method of claim 14, further comprising pre-filtering water from the water source to generate a pre-filtered water stream and feeding the pre-filtered water stream to the reverse osmosis unit.

20. The method of claim 14, further comprising combining at least a portion of the electrodeionization purified stream with at least one dialysis agent to generate a dialysis fluid.
